(19) United States
(12) Patent Application Publication
(10) Pub. No.: US 2007/0266218 A1
(43) Pub. Date: Nov. 15, 2007

(54) Storage system and storage control method for the same

(76) Inventor: Kyosuke Achiwa, Yamato (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/485,271

(22) Filed: Jul. 13, 2006

(30) Foreign Application Priority Data
May 10, 2006 (JP) 2006-131621

(51) Int. Cl. G06F 12/00

(52) U.S. Cl. 711/170

(57) ABSTRACT

A storage system that dynamically allocates storage areas to a volume accessed by a host system, in response to access from the host system, wherein allocation of storage areas to one volume has no impact on any allocation of storage areas to the other volumes is provided.

At least one storage area that can be allocated to a virtual volume is pooled, and upon access from the host system to the virtual volume, a storage area in the pool is allocated to the virtual volume. At this time, upon access from the host system exceeding a limit provided to the host system/the virtual volume for the allocation of the storage area, an error notice is returned to the host system without allocating the storage area in the pool to the virtual volume.

### CROSS-REFERENCES TO RELATED APPLICATIONS

This application relates to and claims priority from Japanese Patent Application No. 2006-131621, filed on May 10, 2006, the entire disclosure of which is incorporated herein by reference.

### BACKGROUND

1. Field of the Invention

The present invention relates to a storage system, and more specifically relates to a storage system and a storage control method for a storage system that use the Allocation On Use (hereinafter referred to as “AOU”) technique, which will be described later.

2. Description of Related Art

With the increase in the amount of data dealt with in computer systems having a storage system and a host system such as a server or a host computer connected to the storage system via a communication path such as a network, storage systems have had increased storage area capacity. A storage system logically defines a volume accessible from a host system, and the host system accesses the physical storage areas constituting this logical volume, making it possible to input/output data to/from storage devices.

Recently, the amount of data dealt with in a host system has been increasing greatly, requiring a great increase in volume size, which is the storage capacity of a logical volume. If a logical volume with a large storage capacity is originally allocated to a host system, there will not be any shortage of storage capacity for the host system, and thus no need to extend the size of storage area allocated to the host system during use. However, if a computer—a host system—does not use so much data, there will be unused capacity in the storage area allocated to the computer, which is a waste of storage capacity. Therefore, JP-A-2005-11316 provides a technique allocating, only when a host system writes to a virtual volume in a storage apparatus, a physical storage area to an area in the virtual volume written to. U.S. Pat. No. 6,823,442 describes a virtual volume accessible from a host system being provided in a storage system and a physical storage area being allocated to the virtual volume. Other art related to the present invention includes that described in JP-A-2005-135116.

### SUMMARY

The applicant has been developing the aforementioned AOU technique in order to effectively utilize storage resources in a storage system. With the AOU technique, a storage system provides a host system with a virtual volume itself having no physical storage areas, and the virtual volume is associated with an aggregate of storage areas called a pool. The storage system allocates a storage area included in the pool to the area in the virtual volume to which the host system write-accessed. This allocation is conducted when the host system accesses the virtual volume.

The AOU technique, with which a storage area is allocated to a volume in response to access from a host system to the volume, provides flexibility in storage area allocation, and can use storage areas effectively, compared to the case where the storage areas for the total capacity of a volume accessible from a host system are originally allocated to the volume. Furthermore, a plurality of virtual volumes can share the same pool, making it possible to use the storage area of the pool effectively. In the storage system, it is possible to provide a host system with a virtual volume of a predetermined size in advance and then add storage capacity to the pool according to the pool usage.

However, when there is write access from a host system to an entire virtual volume (for example, full-formatting of the virtual volume), the storage system allocates storage areas in the pool to the entire virtual volume, and as a result, a large part of the pool's storage areas will be consumed quickly, which could result in possible hazardous effects on the other virtual volumes that share the pool.

Therefore, an object of the present invention is to provide a storage system that dynamically allocates storage areas to a volume accessed by a host system, in response to access from the host system, wherein allocation of storage areas to one volume has no impact on any allocation of storage areas to the other volumes. Another object of the present invention is to provide a storage system that, when there is write access from a host system to an entire virtual volume, prevents excessive consumption of the storage areas of a pool, resulting in no impact on any allocation of storage areas to other volumes. Still another object of the present invention is to provide a storage system that limits access from a rogue host system to the storage system, limiting allocation of storage resources to that host system.

In order to achieve these objects, the present invention provides a storage system that dynamically allocates a storage area to a volume a host system accesses, in response to access from the host system, wherein a limit is provided on access from the host system to the storage system, and when access exceeds the limit, the allocation of storage areas to virtual volumes is limited, even if there are free storage areas that can be allocated from a pool to the virtual volumes.

One embodiment of the present invention is a storage system including: an interface that receives access from a host system; one or more storage resources; a controller that controls data input/output between the host system and the one or more storage resources; control memory that stores control information necessary for executing that control; a virtual volume that the host system recognizes; and a pool having a plurality of storage areas that can be allocated to the virtual volume, the storage areas being provided by the one or more storage resources, wherein: the controller allocates at least one storage area from among the storage areas in the pool to the virtual volume based on access from the host system to the virtual volume, and the host system accesses the storage area allocated to the virtual volume; the control memory includes limit control information limiting the allocation; and the controller limits the allocation of the storage area to the virtual volume based on the limit control information even when a storage area that can be allocated to the virtual volume is included in the pool.

It is preferable that the memory includes, as the control information, a limit value for the storage area allocated to the virtual volume as a result of write access from the host system to the virtual volume, and when the capacity of the storage area allocated to the virtual volume exceeds the limit value, the controller limits the write access.

It is preferable that the memory includes, as control information, a limit value for the allocate-rate for allocating the storage area to the virtual volume, and when the value calculated as the allocate-rate exceeds the limit value, the controller limits the write access.

It is preferable that the limit value is set for the host system, and when the allocation of the storage area -based on write access from the host system reaches the limit value, the controller issues a warning regarding the write access. It is also preferable that the limit value is set for the host system, and when the allocation of the storage area based on write access from the host system reaches the limit value, the controller regards that write access and any subsequent access as errors.

It is preferable that he limit value is set for the virtual volume, and when the allocation of the storage area based on write access from the host system reaches the limit value, the controller issues a warning regarding the write access. It is also preferable that the limit value is set for the virtual volume, and when the allocation of the storage area based on write access from the host system reaches the limit value, the controller regards that write access and any subsequent write access as errors. It is preferable that when the storage areas in the pool already allocated to the virtual volume exceeds a limit set for the pool, the controller limits the allocation of a storage area from among the storage areas in the pool to the virtual volume based on write access from the host system.

It is preferable that the limit value is set for application software operating on the host system, and the controller limits write access from the application software. It is preferable that the controller limits write access for application software operating on the host system, that has a high write access rate to the virtual volume. It is preferable that he limit value varies according to the host system type. It is also preferable that the limit value varies according to the virtual volume usage.

As explained above, the present invention makes it possible to provide a storage system that can control the allocation of storage areas from a pool to a virtual volume so that it has no impact on the other virtual volumes, and also, a storage system that, when there is write access from a host system to an entire virtual volume, prevents excessive consumption of storage areas of a pool, resulting in no impact on the allocation of storage areas to the other virtual volumes. Furthermore, the present invention can provide a storage system that limits access from a rogue host system to the storage system, limiting the allocation of storage resources to that host system.

### BRIEF DESCRIPTION OF THE DRAWINGS

FIG. 1 is a hardware block diagram showing a storage control system including a storage system employing the present invention.

FIG. 2 is a block diagram showing a function of the storage control system shown in FIG. 1.

FIG. 3 is a block diagram showing the relationship between a virtual volume and a pool.

FIG. 4 is a block diagram showing a function of a part of the storage system, which shows the state where storage areas are allocated from a pool to a virtual volume.

FIG. 5 is a block diagram showing a function of a storage system, which explains the processing for prohibiting the allocation of a storage area from a pool to a rogue host system and the processing for allocating a storage area from a pool to a non-rogue host system.

FIG. 6 shows an example of a management table for quotas (limit information) set for host systems.

FIG. 7 shows an example of a volume management table in a storage subsystem.

FIG. 8 shows an example of a table for managing the allocation of a virtual volume to a host system.

FIG. 9 shows an example of a table for managing a pool.

FIG. 10 shows an example of a pool quota management table.

FIG. 11 shows an example of a pool quota initial value table.

FIG. 12 shows an example of a host quota initial value table.

FIG. 13 shows an example of a table holding initial values of virtual volume quotas.

FIG. 14 is a flowchart of the processing executed when a channel controller receives a write command from a host system.

FIG. 15 is a flowchart explaining the processing for allocating a chunk to a virtual volume.

FIG. 16 shows an example of a warning mail sent from a disk controller to a management console when the total amount of chunks assigned to a virtual volume upon write access from a host system exceeds the pool warning quota.

FIG. 17 shows an example of a warning email sent when the total capacity of chunks allocated to a virtual volume exceeds a host warning quota.

FIG. 18 shows an example of a warning email sent when the total capacity of chunks allocated to a virtual volume exceeds a virtual volume warning quota.

FIG. 19 is a flowchart indicating an example of a response to the case where an administrator receives a pool quota warning email.

FIG. 20 is a flowchart for executing the processing for adding a pool.

FIG. 21 is a flowchart indicating an example of a response to the case where an administrator receives a host quota warning email.

FIG. 22 is a flowchart indicating virtual volume initialization processing.

FIG. 23 is a flowchart explaining an example of a response to the case where a storage system administrator receives a virtual volume quota warning email.

FIG. 24 is a flowchart explaining the processing executed by a CPU in a management console when a storage system administrator orders the creation of a virtual volume via the management console.

### DETAILED DESCRIPTION OF PREFERRED EMBODIMENTS

Embodiments of the present invention will be explained below with reference to the drawings. In the drawings explained below, the same parts are provided with the same reference numerals, so their explanations will not be repeated.

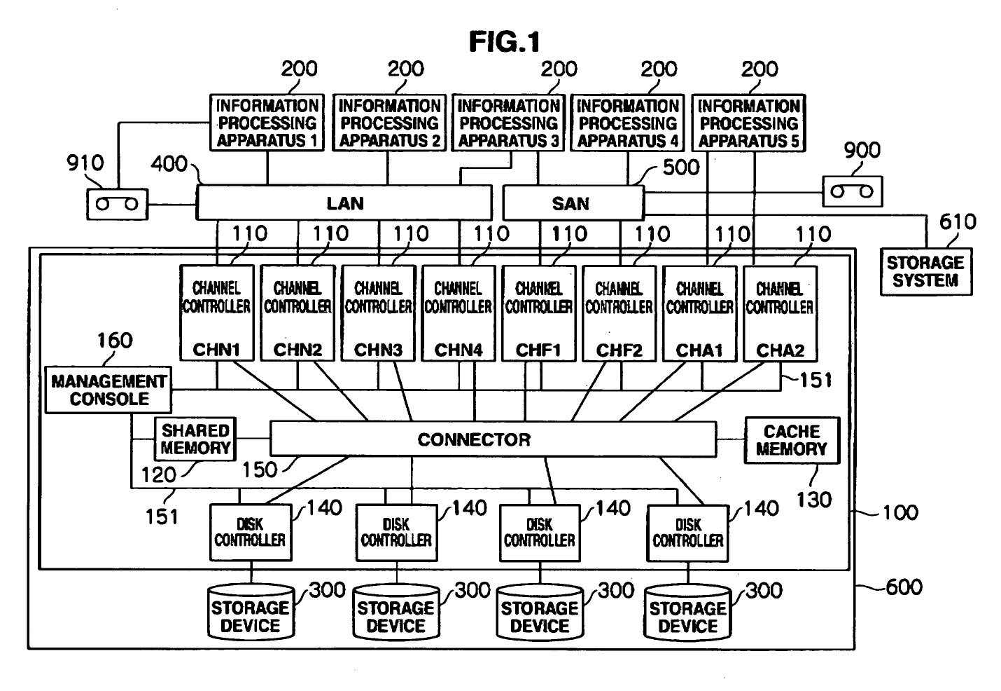

FIG. 1 is a hardware block diagram showing a storage control system including a storage system 600 (referred to as a “storage apparatus” from time to time) employing the present invention. The storage system 600 includes a plurality of storage devices 300, and a storage device control unit (controller) 100 that controls input/output to/from the storage devices 300 in response to input/output requests from information processing apparatuses 200.

The information processing apparatuses 200 correspond to host systems, and they are servers (hosts) having a CPU and memory, or storage apparatus management computers. They may be workstations, mainframe computers or personal computers, etc. An information processing apparatus 200 may also be a computer system consisting of a plurality of computers connected via a network. Each information processing apparatus 200 has an application program executed on an operating system. Examples of the application program include a bank automated telling system and an airplane seat reservation system. The servers include an update server and a backup server that performs backup at the backend of the update server.

The information processing apparatuses 1 to 3 (200) are connected to the storage apparatus 600 via a LAN (Local Area Network) 400. The LAN 400 is, for example, a communication network, such as an Ethernet® or FDDI, and communication between the information processing apparatuses 1 to 3 (200) and the storage system 600 is conducted according to the TCP/IP protocol suite. File name-designated data access requests targeting the storage system 600 (file-based data input/output requests; hereinafter, referred to as “file access requests”) are sent from the information processing apparatuses 1 to 3 (200) to channel controllers CHN1 to CHN4 (110), which are described later.

The LAN 400 is connected to a backup device 910. The backup device 910 is, for example, a disk device, such as an MO, CD-R, DVD-RAM, etc., or a tape device, such as a DAT tape, cassette tape, open tape, cartridge tape, etc. The backup device 910 stores a backup of data stored in the storage devices 300 by communicating with the storage device control unit 100 via the LAN 400. Also, the backup device 910 can communicate with the information processing apparatus 1 (200) to obtain a backup of data stored in the storage devices 300 via the information processing apparatus 1 (200).

The storage device control unit 100 includes channel controllers CHN1 to CHN4 (110). The storage device control unit 100 relays write/read access between the information processing apparatuses 1 to 3, the backup device 910, the storage devices 300 via the channel controllers CHN1 to CHN4 (110) and the LAN 400. The channel controllers CNH1 to CHN4 (110) individually receive file access requests from the information processing apparatuses 1 to 3. In other words, the channel controllers CHN1 to CHN4 (110) are individually provided with network addresses on the LAN 400 (e.g., IP addresses), and can individually act as NAS devices, and individual NAS devices can provide NAS services as if they exist as independent NAS devices.

The above-described arrangement of the channel controllers CHN1 to CHN4 (110) that individually provides NAS services in one storage system 600 has NAS servers, which have conventionally been operated with independent computers, collected in one storage system 600. Consequently, collective management in the storage system 600 becomes possible, improving the efficiency of maintenance tasks, such as various settings and controls, failure management and version management,

The information processing apparatuses 3 and 4 (200) are connected to the storage device control unit 100 via a SAN 500. The SAN 500 is a network for sending/receiving data to/from the information processing apparatuses 3 and 4 (200) in blocks, which are data management units for storage resources provided by the storage devices 300. The communication between the information processing apparatuses 3 and 4 (200) and the storage device control unit 100 via the SAN 500 is generally conducted according to SCSI protocol. Block-based data access requests (hereinafter referred to as “block access requests”) are sent from the information processing apparatuses 3 and 4 (200) to the storage system 600.

The SAN 500 is connected to a SAN-adaptable backup device 900. The SAN-adaptable backup device 900 communicates with the storage device control unit 100 via the SAN 500, and stores a backup of data stored in the storage devices 300.

In addition to the channel controller CHN1 to CHN4, the storage device control unit 100 also includes channel controllers CHF1, CHF2, CHA1 and CHA2 (110). The storage device control unit 100 communicates with the information processing apparatuses 3 and 4 (200) and the SAN-adaptable backup device 900 via the channel controllers CHF1 and CHF2 (110) and the SAN 500. The channel controllers processes access commands from host systems.

The information processing apparatus 5 (200) is connected to the storage device control unit 100, but not via a network such as the LAN 400 and the SAN 500. The information processing apparatus 5 (200) is, for example, a mainframe computer. The communication between the information processing apparatus 5 (200) and the storage device control unit 100 is conducted according to a communication protocol, such as FICON (Fibre Connection)®, ESCON (Enterprise System Connection)®, ACONARC (Advanced Connected Architecture)®, FIBARC (Fibre Connection Architecture)®. Block access requests are sent from the information processing apparatus 5 (200) to the storage system 600 according to any of these communication protocols. The storage device control unit 100 communicates with the information processing apparatus 5 (200) via the channel controllers CHA1 and CHA2 (110).

The SAN 500 is connected to another storage system 610. The storage system 610 enables the information processing apparatuses 200 and the storage apparatus 600 providing storage resources the storage system 610 has to the storage device control unit 100. The storage apparatus 600's storage resources recognized by the information processing apparatuses 200 has been expanded by the storage apparatus 610. The storage system 610 may be connected to the storage system 600 with a communication line, such as ATM, other than the SAN 500. The storage system 610 can also be directly connected to the storage system 600.

As explained above, the channel controllers CHN1 to CHN4, CHF1, CHF2, CHA1, and CHA2 (100) coexist in the storage system 600, making it possible to obtain a storage system connectable to different types of networks. In other words, the storage system 600 is a SAN-NAS integrated storage system that is connected to the LAN 400 using the channel controllers CHN1 to CHN4 (110), and also to the SAN 500 using the channel controllers CHA1 and CHA2 (100).

A connector 150 interconnects the respective channel controllers 110, shared memory 120, cache memory 130, and the respective disk controllers 140. Commands and data are transmitted between the channel controllers 110, the shared memory 120, the cache memory 130, and the controllers 140 via the connecter 150. The connector 150 is, for example, a high-speed bus, such as an ultrahigh-speed crossbar switch that performs data transmission by high-speed switching. This makes it possible to greatly enhance the performance of communication with the channel controllers 110, and also to provide high-speed file sharing, and high-speed failover, etc.

The shared memory 120 and the cache memory 130 are memory devices that are shared between the channel controllers 110 and the disk controllers 140. The shared memory 120 is used mainly for storing control information or commands, etc., and the cache memory 130 is used mainly for storing data. For example, when a data input/output command received by a channel controller 110 from an information processing apparatus 200 is a write command, the channel controller 110 writes the write command to the shared memory 120, and also writes write data received from the information processing apparatus 200 to the cache memory 130. Meanwhile, the disk controller 140 monitors the shared memory 120, and when it judges that the write command has been written to the shared memory 120, it reads the write data from the cache memory 130 based on the write command, and writes it to the storage devices 300.

Meanwhile, when a data input/output command received by a channel controller 110 from an information processing apparatus 200 is a read command, the channel controller 110 writes the read command to the shared memory 120, and checks whether the target data exists in the cache memory 130. If the target data exists in the cache memory 130, the channel controller 110 reads the data from the cache memory 130 and sends it to the information processing apparatus 200. If the target data does not exist in the cache memory 130, the disk controller 140, having detected that the read command has been written to the shared memory 120, reads the target data from the storage devices 300 and writes it to the cache memory 130, and notifies the shared memory to that effect. The channel controller 110, upon detecting that the target data has been written to the cache memory 130, having monitored the shared memory 120, reads the data from the cache memory 130 and sends it to the information processing apparatus 200.

The disk controllers 140 convert logical address-designated data access requests targeting the storage devices 300 sent from the channel controllers 110, to physical address-designated data access requests, and write/read data to/from the storage devices 300 in response to I/O requests output from the channel controllers 110. When the storage devices 300 have a RAID configuration, the disk controllers 140 access data according to the RAID configuration. In other words, the disk controllers 140 control HDDs, which are storage devices, and they control RAID groups. Each of the RAID groups consists of storage areas made from a plurality of HDDs.

A storage devices 300 includes single or multiple disk drives (physical volumes), and provides a storage area accessible from the information processing apparatuses 200. In the storage area provided by the storage devices 300, logical volume(s), which are formed from the storage space in single or multiple physical volumes, are defined. Examples of the logical volumes defined in the storage devices 300 include a user logical volume accessible from the information processing apparatuses 200, and a system logical volume used for controlling the channel controllers 110. The system logical volume stores an operating system executed in the channel controllers 110. A logical volume provided by the storage devices 300 to a host system is a logical volume accessible from the relevant channel controller 110. Also, a plurality of channel controllers 110 can share the same logical volume.

For the storage devices 300, for example, hard disk drives can be used, and semiconductor memory, such as flash memory, can also be used. For the storage configuration of the storage devices 300, for example, a RAID disk array may be formed from a plurality of storage devices 300. The storage devices 300 and the storage device control unit 100 may be connected directly, or via a network. Furthermore, the storage devices 300 may be integrated with the storage device controller 100.

The management console 160 is a computer apparatus for maintaining and managing the storage system 600, and is connected to the respective channel controllers 110, the disk controllers 140 and the shared memory 120 via an internal LAN 151. An operator can perform the setting of disk drives in the storage devices 300, the setting of logical volumes, and the installation of microprograms executed in the channel controllers 110 and the disk controllers 140 via the management console 160. This type of control may be conducted via a management console, or may be conducted by a program operating on a host system via a network.

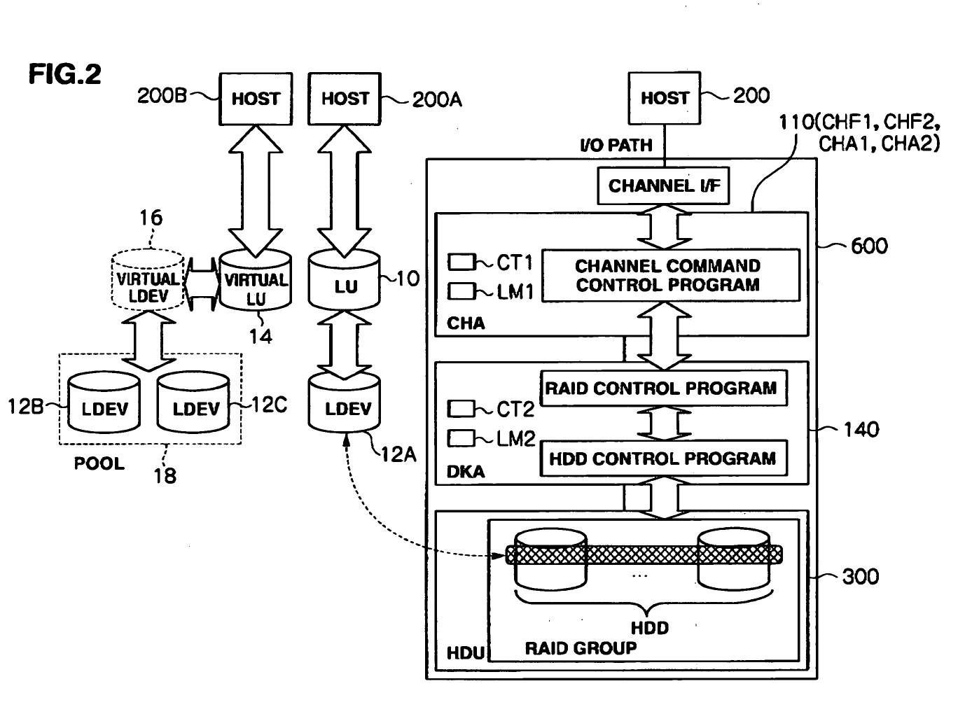

FIG. 2 is a block diagram showing functions of the storage control system shown in FIG. 1. A channel controller 110 includes a microprocessor CT1 and local memory LM1, and a channel command control program is stored in the local memory LM1. The microprocessor CT1 executes the channel command control program with reference to the local memory LM1. The channel command control program provides LUs to the host systems. The channel command control program processes access commands sent from the host systems to the LUs to convert them to access to LDEVs. The channel command control program may access the LDEVs without access from the host systems. An LDEV is a logical volume formed from a part of a RAID group. Although a virtual LDEV is accessible from a host system, it has no physical storage area. A host system accesses not an LDEV but an LU. An LU is a storage area unit accessed by a host system. Some of the LUs are allocated to virtual LDEVs. Hereinafter, for ease of explanation, LUs allocated to virtual LDEVs are referred to as “virtual LUs” in order to distinguish between them and LUs allocated to non-virtual LDEVs.

A disk controller 140 includes a microprocessor CT2 and local memory LM2. The local memory LM2 stores a RAID control program and an HDD control program. The microprocessor CT2 executes the RAID control program and the HDD control program with reference to the local memory LM2. The RAID control program configures a RAID group from a plurality of HDDs, and provides LDEVs to the channel command program in the upper tier. The HDD control program executes data reading/writing from/to the HDDs in response to requests from the RAID control program in the upper tier.

A host system 200A accesses a LDEV12A via an LU 10. The storage area for a host system 200B is formed using the AOU technique. The host system 200B accesses a virtual LDEV 16 via a virtual LU 14. The virtual LDEV 16 is allocated a pool 18, and LDEVs 12B and 12C are allocated to this pool.

A virtual LDEV corresponds to a virtual volume. A pool is a collection of (non-virtual) LDEVs formed from physical storage areas that are allocated to virtual LDEVs. Incidentally, a channel I/F and an I/O path are interfaces for a host system to access a storage subsystem, and may be Fibre Channel or iSCSI.

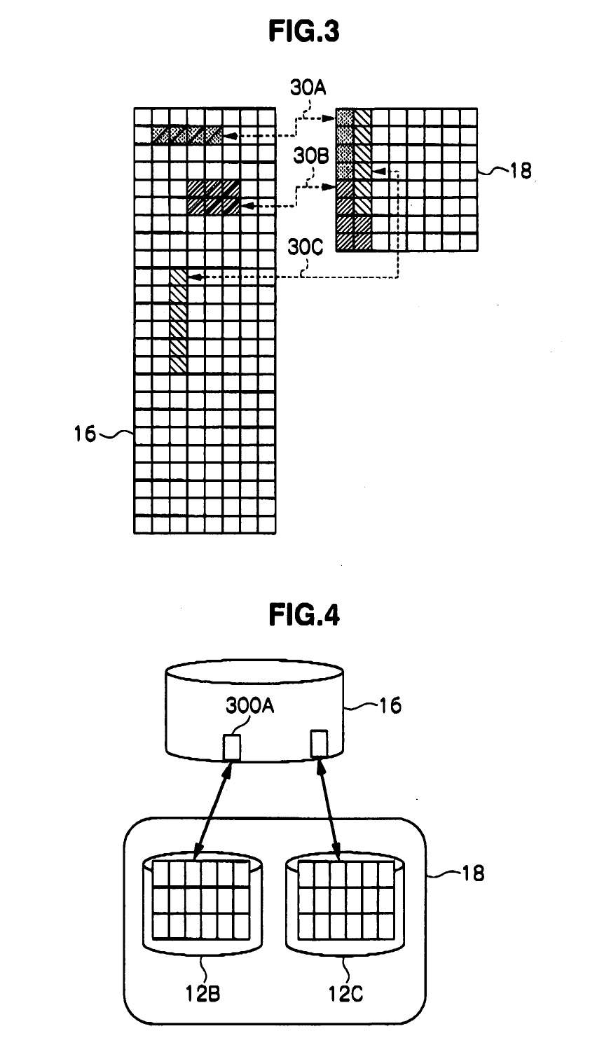

FIG. 3 is a block diagram indicating the relationship between a virtual volume and a pool. A host system accesses the virtual volume 16. The accessed area of the virtual volume is mapped onto the pool (physical storage apparatus) 18. This mapping is created dynamically in response to access from the host system to the virtual volume, and is used by the storage system thereafter. The unused area of the virtual volume area does not consume the physical storage apparatus, making it possible to provide a certain virtual volume capacity in advance, and gradually add storage resources (LDEVs) to the pool with reference to the pool 18 usage.

As shown in FIG. 4, in its initial state, the virtual volume 16 has no physical area for storing data. “Chunks” 300A, which are physical storage area units, are assigned from the pool 18 to the virtual volume 16 only for the parts write-accessed by a host system. Data is read/written from/to a host system in blocks of 512 Bytes. The chunk size here is 1 MB, which is larger than the size of these blocks, but chunks may be any size. The LDEVs 12B and 12C are pool volumes (pool LDEVs) included in the pool 18.

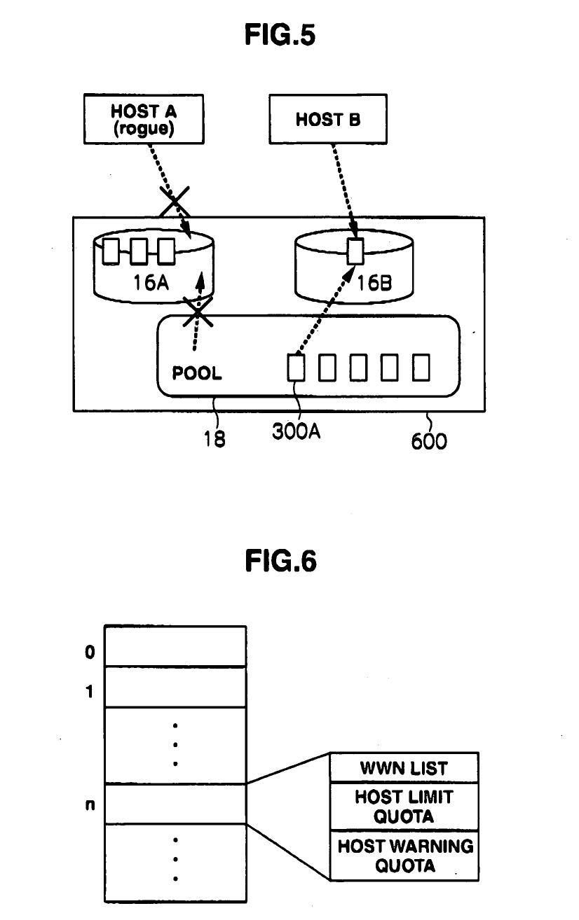

FIG. 5 is a block diagram indicating an example of typical control operation for the present invention. Upon access from a host system A to a virtual volume 16A, the storage system 600 does not assign a chunk 300A to the virtual volume 16A, despite there being chunks, which are physical storage areas, existing in the pool 18. Meanwhile, upon access from a host system B to a virtual volume 16B, the storage system 600 assigns a chunk 300A, which is a physical storage area unit, to the virtual volume 16B. The virtual volume 16A and the virtual volume 16B are allocated to the pool 18.

The host system A, compared to the host system B, has ‘rogue’ accesses (i.e., too-many writes) to the AOU volume (virtual volume) 16A. The storage system 600 may judge a host system itself as a rogue one from the beginning, or may also evaluate or judge a host system making write access to virtual volumes as a “rogue host” based on the amount of write access from the host system. The latter case is, for example, when there is a great amount of write access from the host system A to virtual volumes, and the amount of access exceeds access limits called “quotas”. Access from a host system B does not exceed the quotas. These quotas include those set for a host system, those set for a virtual volume, and those set for a pool.

A quota set for a host system is registered in advance by, for example, a storage system administrator in a control table in the shared memory (120 in FIG. 1). The administrator sets a quota management table in the shared memory 120 via the management console shown in FIG. 1. A plurality of virtual volumes 16A and 16B is created from the same pool. A characteristic of the control operation here is that, when write access from a host system to virtual volumes exceeds an access limit (for the host system), a physical storage area (i.e., chunk) in a pool will not be allocated to the virtual volumes because of write access from the host system even if there are unused chunks in the pool able to be allocated to the virtual volumes. As a result, it is possible to prevent chunks in the pool being consumed by a specific host system or virtual volume alone.

FIG. 6 is a management table for quotas set for host systems. This management table is to provide a quota for chunk allocation to each host system. Numerals 0, 1, . . . n show host numbers, i.e., entry numbers. Each entry has a list for WWNs of host systems that access virtual volumes defined for AOU, a host limit quota, and a host warning quota. A plurality of host WWNs can be set taking into account a multi-path or cluster configuration.

The quotas include two kinds: a host warning quota and a host limit quota. The host warning quota is a first threshold value for the total capacity of chunks assigned to virtual volumes as a result of write access from a host system, and when the capacity of chunks allocated to the virtual volumes exceeds the first threshold value, the storage system gives the storage administrator a warning. The quota is set in GBs. The host limit quota is a second threshold for the total capacity of chunks assigned to virtual volumes as a result of write access from a host system, and when the total capacity of chunks assigned to the virtual volumes as a result of write access from a host system exceeds the second threshold value, the storage system makes any subsequent write access from the host system (involving chunk allocation) to an abnormal termination. This quota is also set in GBs. The limit value (second threshold value) is set to a capacity greater than the capacity for the warning value (first threshold value).

A quota may be determined by the total capacity of chunks allocated to a virtual volume, or by the ratio of the allocated storage area of a virtual volume to the total capacity of the virtual volume, or by the ratio of the allocated storage area of a pool to the total capacity of the pool. A quota may also be determined by the rate (frequency/speed) at which chunks are allocated to a virtual volume. A host system that consumes a lot of chunks is judged a rogue host according to this host quota management table, and the storage system limits or prohibits chunk allocation for access from this host system. The storage system can calculate a chunk allocation rate by periodically clearing the counter value of a counter that counts the number of chunks allocated to a virtual volume.

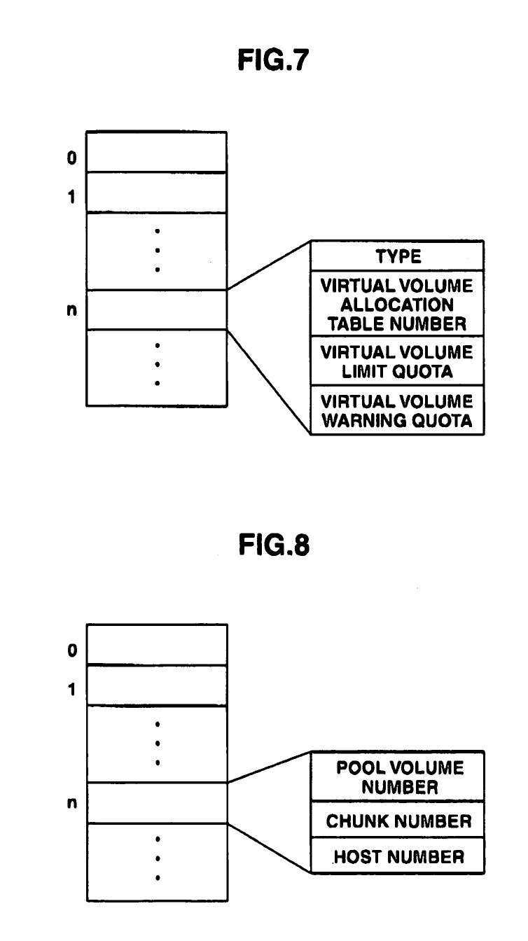

FIG. 7 is a volume management table in a storage subsystem. This management table is not for setting quotas for host systems like in the case shown in FIG. 6, but for setting quotas for virtual volumes. Numerals 0, 1, . . . n indicate volume numbers, i.e., entry numbers. Each entry has a volume type, and if the volume is a virtual volume, it also has a volume allocation table number, a virtual volume limit quota, and a virtual volume warning quota. The volume types include 0 (normal volume), 1 (virtual volume), 2 (pool volume), and −1 (unused volume).

The “limit quota” and “warning quota” of a virtual volume are the same kind as the quotas set for a host system explained with reference to FIG. 6. The quotas explained here are defined with the percentage (%) of the total capacity of a virtual volume.

FIG. 8 shows a table for managing the allocation of chunks to a virtual volume. Each virtual volume has this table. Each of the entries (1, 2, . . . n) has a number for a pool volume in a pool allocated to the relevant volume, the chunk number in the pool volume allocated to the virtual volume, and the host number for the host system that issued the write access request resulting in the allocation of the chunk. When no chunk is allocated, “−1”s are set in the pool volume number, chunk number and host number in this entry.

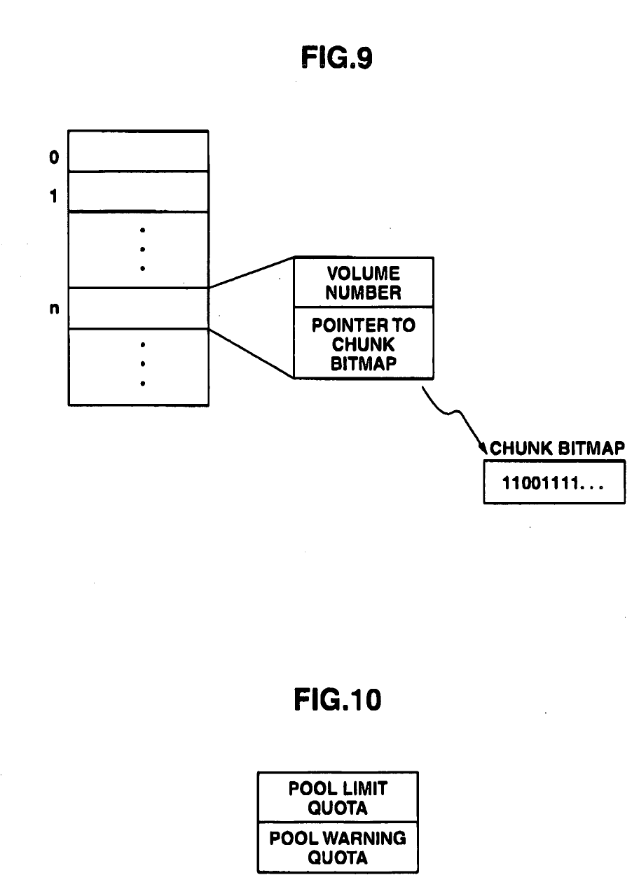

FIG. 9 is a table for managing a pool, and the table has one entry for each volume in the pool. Each entry (0, 1, . . . n) has a pool volume number, and a pointer to a chunk bitmap. The chunk bitmap is information indicating whether the chunks in a volume are used or not, with 1 bit corresponding to one chunk. “1” indicates that the chunk is used (i.e., it has already been allocated to a virtual volume), and “0” indicates that the chunk is unused (i.e., it has not yet been allocated to a virtual volume). A chunk bitmap is provided for each volume included in a pool. The pool management table holds control information regarding whether each pool volume is valid or invalid. In order to disable the allocation of a pool volume to a virtual volume, “−1” is set for the pool volume number, and the “pool volume number” is set to enable that allocation.

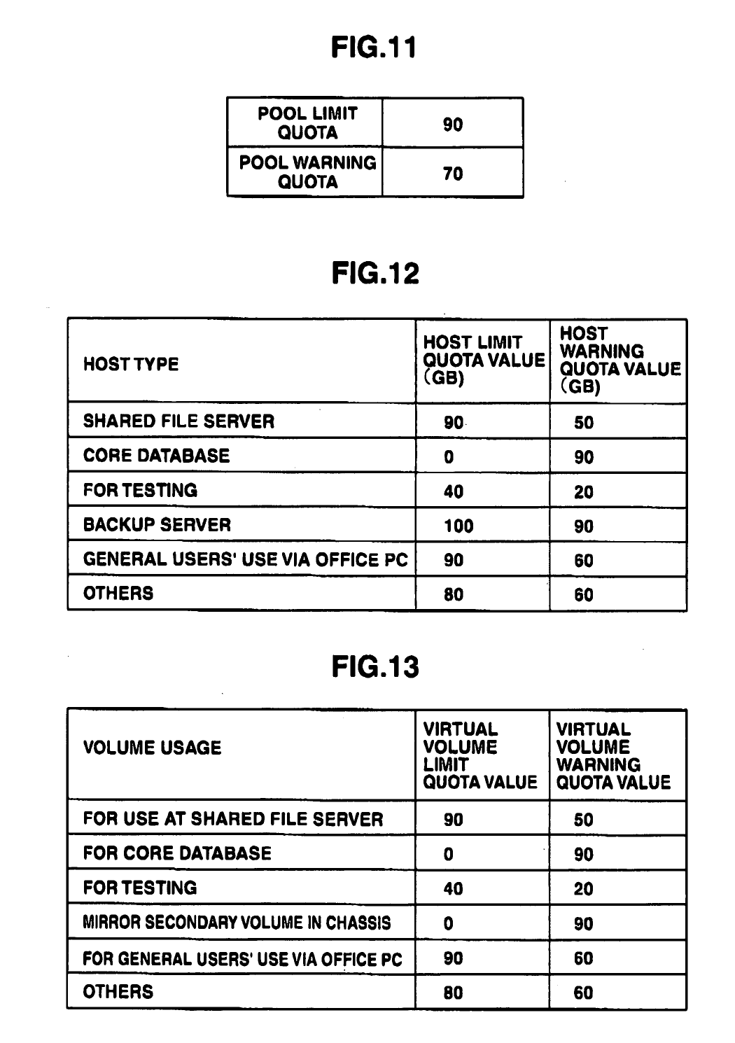

FIG. 10 shows a pool quota management table. Quotas are set for a pool, and write access limitation for a host system is enabled only when the utilization ratio of the pool is high. Pool quotas are a pool limit quota and a pool warning quota. When the ratio of chunks already allocated to virtual volumes in a pool exceeds this pool limit quota, the storage system prohibits or suspends write access based on the virtual volume limit quota and/or the host limit quota. When the ratio of chunks already allocated to virtual volumes in the pool exceeds the pool warning quota, the storage system issues a warning to the storage administrator. FIG. 11 shows an example of a pool quota initial value table. In FIG. 11, the pool warning quota is set to a 70% ratio for chunks allocated in a pool, and the pool limit quota is set to a 90% ratio for chunks in the pool.

FIG. 12 shows an example of a host quota initial value table. It is possible to set different limit and warning quota values depending on the host type. The value “0” indicates that there is no limit quota value provided. The limit quota value “0” is set for a mission critical database because there will be a large impact if access from a host system, which serves as a mission critical database, to the storage system is halted. FIG. 13 is a table for holding initial values for quotas for virtual volumes. The quota value may be changed or may also have “0” in the virtual volume limit quota value (no quota provided) depending on the usage or properties of each volume. The initial value tables shown in FIG. 10 to FIG. 13 exist in the shared memory in the storage system, and are referred to when the management console (160 in FIG. 1) executes the processing for creating a virtual volume. When a plurality of host systems is connected to the storage system, quotas (i.e., limit and warning) can be set for each host system, and if the storage system has a plurality of virtual volumes, quotas can be set for each virtual volume.

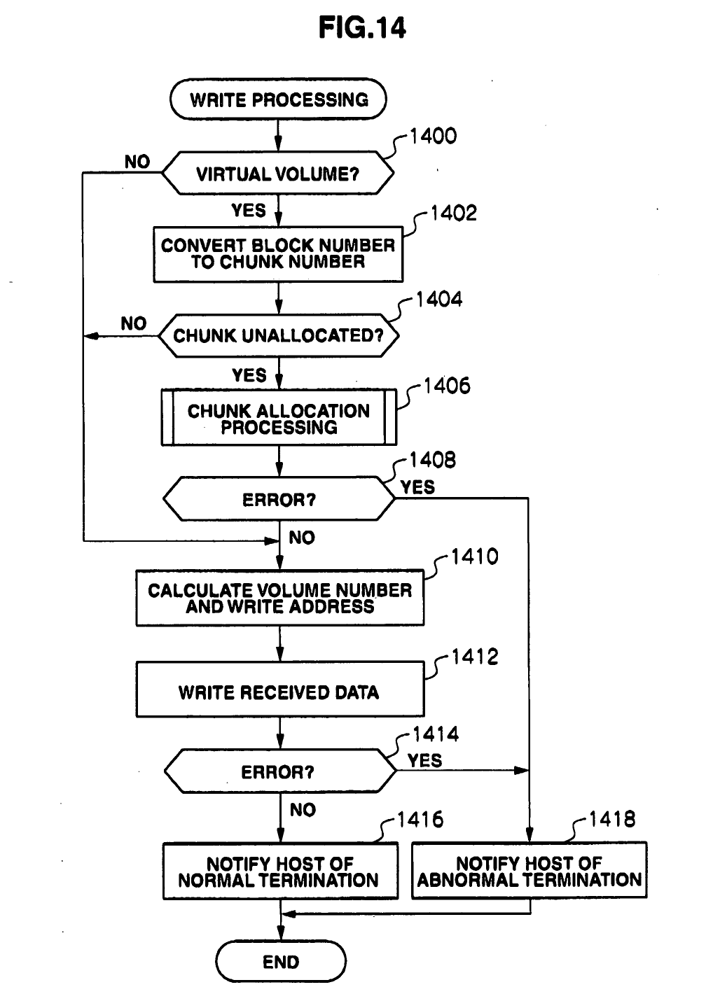

FIG. 14 shows the processing executed when a channel controller receives a write command from a host system in a flowchart. The channel controller, referring to the channel command control program and the control table, executes the processing shown in the FIG. 14 flowchart. The channel controller, upon receipt of a write command from a host system, starts write processing, and then determines whether or not the target volume type for the write command is a virtual volume (1400). The channel controller accesses the entry for the access target volume based on the volume management table (FIG. 7), and reads the volume type of this entry to determine whether or not the volume is a virtual volume.

If the volume accessed by the host system is a virtual volume, the channel controller converts the block addresses for the virtual volume accessed by the host system to a chunk number (1402). When the host system accesses the virtual volume with a logical block address, the channel controller can recognize the chunk number (entry in the virtual volume allocation table in FIG. 8) by dividing the logical block address by the chunk size. The virtual volume allocation table shown in FIG. 8 manages virtual volumes using their chunk numbers. The channel controller accesses the entry in the virtual volume allocation table to check whether or not the volume number is “−1”. If the volume number is “−1”, the channel controller determines that no chunk has been allocated from the pool to the area in the virtual volume accessed by the host system, and proceeds to chunk allocation processing. The chunk allocation processing will be described later.

Next, the channel controller checks whether or not an error has occurred, and if an error has occurred, notifies the host system of an abnormal termination (1418). Meanwhile, if no error has occurred, the channel controller calculates the pool volume number for the pool volume having the chunks allocated the write target block number, and the block address corresponding to the chunks (1410). Subsequently, the channel controller writes write data to this address area (1412), and then checks whether or not a write error has occurred (1414). If no error has occurred, the channel controller notifies the host system of a normal termination (completion) (1416), and if an error has occurred, notifies the host system of an abnormal termination. The channel controller proceeds to step 1410 when the target volume accessed by the host system is not a virtual volume, or when the chunk is already allocated to a virtual volume.

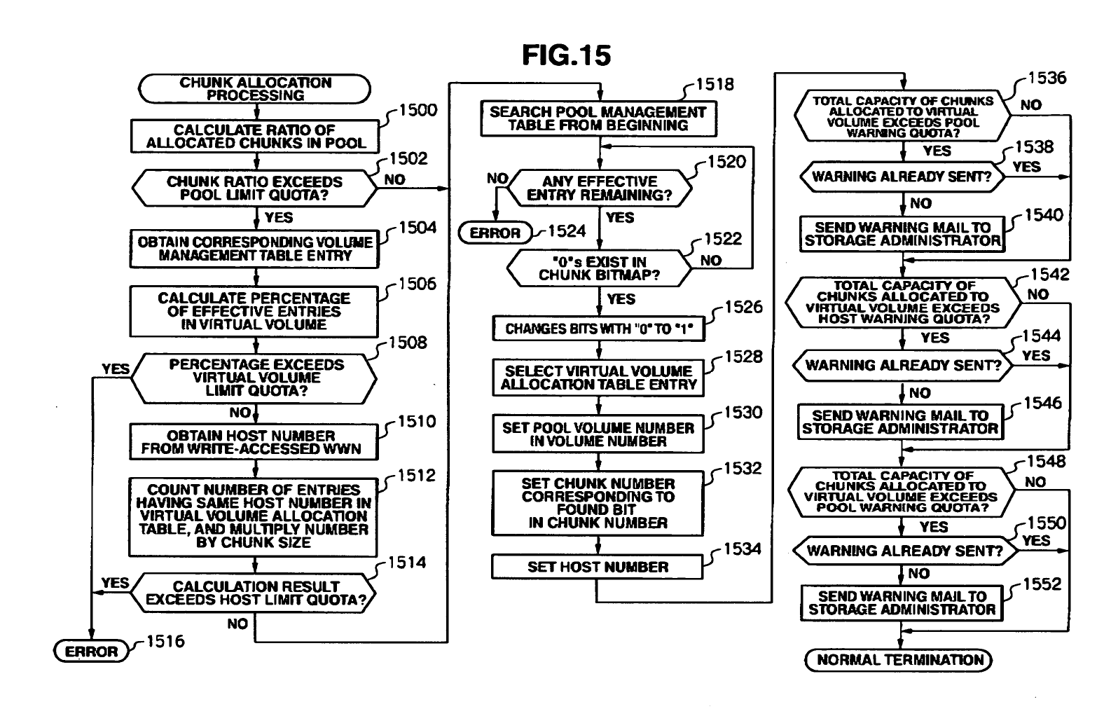

FIG. 15 is a flowchart explaining the processing for allocating a chunk to the virtual volume (1406 in FIG. 14). A disk controller executes the processing shown in this flowchart with reference to the aforementioned control tables and based on the HDD control program. The disk controller scans the entries in the pool management table (FIG. 9) from the beginning to calculate the ratio of the “1” bits in each of the chunk bitmaps, obtaining the ratio of chunks allocated to each virtual volume in the pool (1500). If the allocated chunk ratio exceeds the pool limit quota (1502), the disk controller performs the processing for preventing write access from a host system based on the virtual volume limit quota and the host limit quota. If the allocated chunk ratio does not exceed the pool limit quota, the disk controller performs chunk allocation.

When the allocated chunk ratio exceeds the pool limit quota, the disk controller, referring to the volume management table (FIG.7), obtains the entry number (volume number) for the virtual volume that is the target for the write access from the host system. The disk controller obtains a virtual volume allocation table number from this volume number to calculate the percentage of valid entries, i.e., those not having the pool volume allocation number “−1” (1506). This percentage indicates the ratio of the total capacity of chunks allocated to a virtual volume to the capacity of the virtual volume. The disk controller determines whether or not this ratio exceeds the virtual volume limit quota (1508), and upon a negative result, the disk controller, referring to the WWN lists in the host quota management table, obtains the host number (entry number) from the WWN that is write-accessed by the host system (1510).

The disk controller, referring to all the virtual volume allocation tables, counts the number of entries having the same host number as the one obtained, and multiplies the number by the chunk size (1512). The disk controller determines whether or not the calculation result exceeds the host limit quota for the host system that write-accessed to the storage system (1514). Upon a negative result, chunk allocation processing is executed. If the disk controller determines that this ratio exceeds the virtual volume limit quota (1508), or if the calculation result 1512 exceeds the virtual volume limit quota or the host limit quota, the disk controller returns an error notice to the host system (1516).

Next, the chunk allocation processing will be explained. A disk controller scans the entries in the pool management table (FIG. 9) from the beginning (1518) to check whether or not a valid entry (the pool volume number is not “−1”) is included (1520). Upon a negative result, a channel controller returns an error notice to the host system.

If there is a valid entry included, the disk controller checks whether or not a “0” is stored in the chunk bitmap for the valid entry (1522). If no “0” is stored, the disk controller checks whether a “0” is stored in the chunk bitmaps for other entries, and if a “0” is found in a chunk bitmap, changes the bit to “1” (1526). Subsequently, the disk controller selects the corresponding entry in the virtual volume allocation table based on the chunk number calculated at step 1402 in FIG. 14, sets the pool volume number in the volume number in the entry, also sets the chuck number corresponding to the bit changed to “1” in the chunk bitmap, and obtain a host number (entry) with reference to the host quota management table and based on the WWN for the host system having issued write access, and then registers the host number in the entry in the virtual volume allocation table (1528 to 1534).

The disk controller then determines whether or not the total capacity of chunks assigned to virtual volumes by write access from host systems exceeds the pool warning quota (1536), and if it exceeds the pool warning quota, the disk controller determines whether or not a warning has been sent to the management console (1538), and if it has not yet been sent, sends a warning email to the management console (1540). Subsequently, the disk controller checks whether the total capacity of chunks assigned to virtual volumes by write access from the host system exceeds the host warning quota (1542), and if no warning has been sent to the management console, sends a warning email to the management console (storage administrator) (1546). The similar processing is performed for the virtual volume warning quota (1548 to 1552). Upon the end of the above processing, the storage system notifies the host system of a normal termination for the write access from the host system.

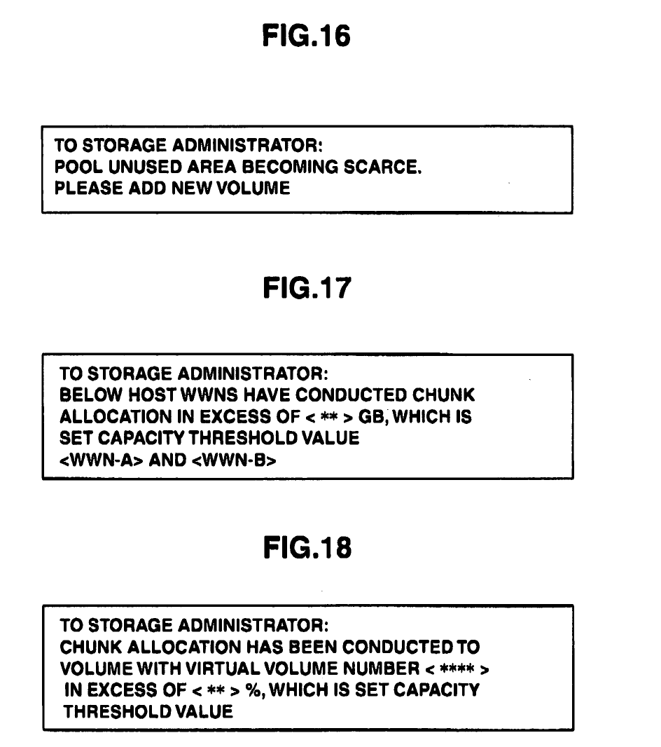

FIG. 16 shows an example of a warning email sent from a disk controller to the management console when the total capacity of chunks allocated to virtual volumes by write access from host systems exceeds the pool warning quota. FIG. 17 shows the content of a warning email sent when the total capacity of chunks allocated to virtual volumes because of write access from a host system exceeds the host warning quota. <**> denotes a value for a host warning quota, <WWN-A> and <WWN-B> are the host system's WWN lists. FIG. 18 shows the content of a warning email sent when the total capacity exceeds the virtual volume warning quota. <****>denotes a virtual volume number, and <**> % is a value for a virtual volume warning quota.

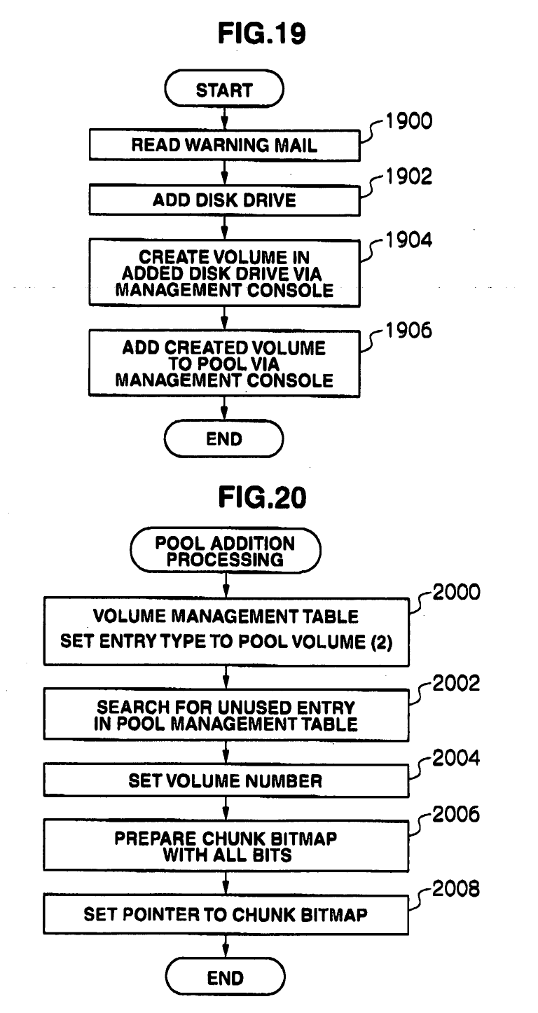

FIG. 19 is a flowchart indicating an example of a response when a storage system administrator receives a warning email for a pool warning quota. The administrator reads the warning email (1900), and then adds disk drives to the storage subsystem (1902). The administrator creates volumes in the added disk drives via the management console (1904). The entries for the volumes are set in the volume management table with the volume type “normal” immediately after the creation of the volumes. The administrator adds volumes created in a pool via the management console to the storage system (1906).

As shown In FIG. 20, a CPU in the management console executes pool addition processing. The CPU sets the type in the entry in the volume management table to pool volume (“2”) (2000). The CPU searches for an unused entry in the pool management table (2002), and sets a volume number for it (2004). The CPU prepares a chunk bitmap for this volume number with all “0”s (2006). Next, the CPU sets a pointer to the chunk bitmap (2008).

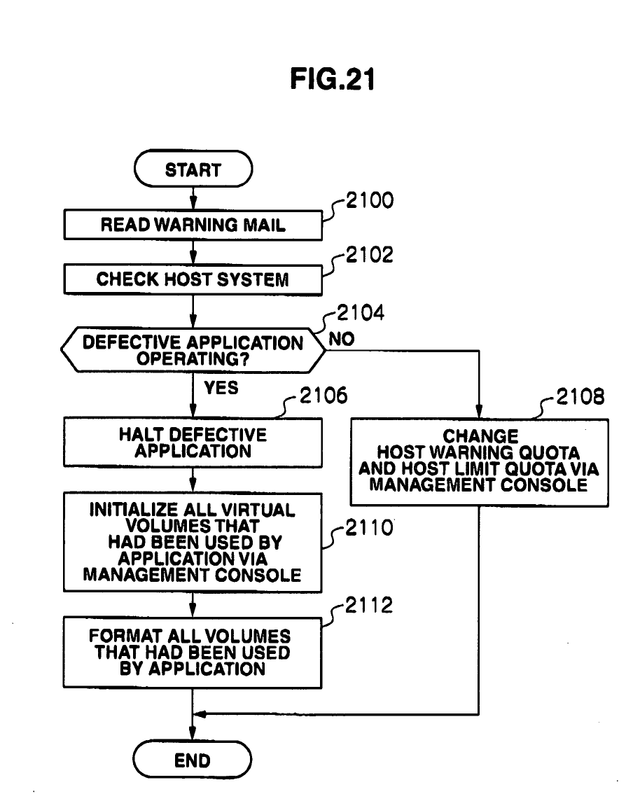

FIG. 21 shows an example of a response to the case where the administrator receives a host quota warning email. The administrator reads the warning email (2100), and logs-in to and checks the host system specified in the warning email (2102). The administrator determines whether or not any rogue application (i.e., one that issues many write accesses) is operating on this host system, and upon a negative result, the administrator considers the host warning quota as not being proper, and changes the host warning quota and the host limit quota via the management console (2108). If a rogue application is operating, the administrator halts the operation of the application on the host system (2106). The administrator initializes all the virtual volumes that had been used by the application via the management console (2110). Then, all the volumes that had been used by the application are formatted (2112).

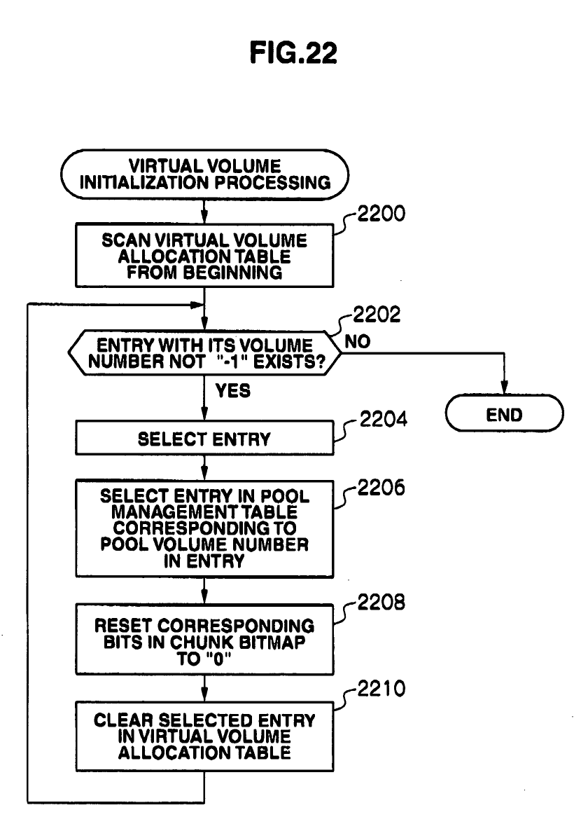

FIG. 22 is a flowchart indicating virtual volume initialization processing, which is executed by the CPU in the management console. The CPU scans the entries in the virtual volume allocation table from the beginning (2200), and determines whether or not any entry with the volume entry number not being “−1” exists (2202), and if no such entry exists, the processing ends. If such an entry is determined as existing, the CPU selects this entry (2204), and then selects the entry in the pool management table corresponding to the pool volume number included in that entry (2206). Then all the bits in the corresponding chunk bitmap are reset to “0”s (2208). The CPU clears the selected virtual volume allocation table entry, i.e., changes all of the pool volume number, the chunk number, and the host number for the entry to “−1” (2210).

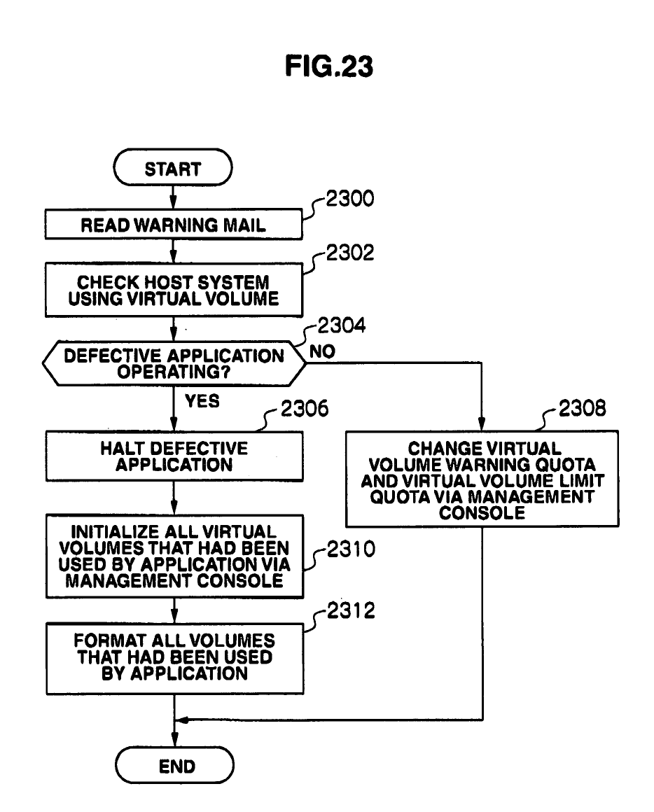

FIG. 23 shows an example of a response when a storage system administrator receives a virtual volume quota warning email. The administrator reads the warning email (2300), and checks the host systems that use the virtual volume specified in the warning email (2302). Then the administrator checks the host systems as to whether or not any rogue application(s) is operating on the host systems (2304). Upon a negative result, the administrator changes the virtual volume warning quota and the virtual volume limit quota via the management console (2308).

Upon an affirmative result at step 2304, the administrator halts the operation of the rogue application(s) on the host system(s) (2306). The administrator initializes all the virtual volumes that had been used by the application(s) via the management console (2310), and then formats all volumes that had been used by the application(s) (2312).

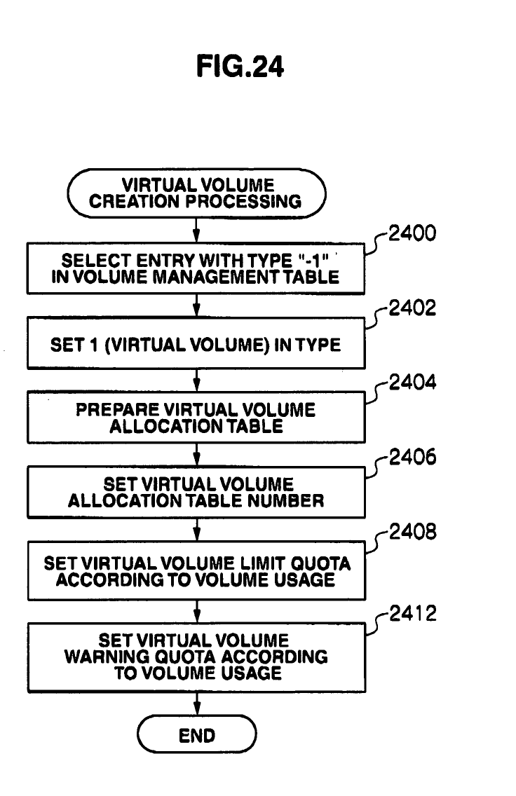

FIG. 24 is a flowchart explaining the processing executed by the CPU in the management console when a storage system administrator orders creation of a virtual volume via the management console. The storage system administrator, when creating a virtual volume, designates the size and usage of the volume. The CPU selects an entry with the type “−1” in the volume management table (2400), and sets “1” (virtual volume) in the type (2402). Subsequently, the CPU searches an unused virtual volume allocation table and initializes all the entries in the table with “−1” (2404). The CPU sets the virtual volume allocation table number and also sets the virtual volume limit quota and the virtual volume warning quota according the volume usage (2406 to 2412).

As explained above, especially in FIG. 15, when the allocation of storage areas (chunks) in a pool exceeds the pool limit quota, the storage system refers to the virtual volume limit quota and the host limit quota, and when the allocation of chunks to the virtual volume (or from the host system exceeds these limit quotas, returns write errors to the host system, without assigning a chunk to the virtual volume in response to write access from the host system that initiated that allocation.

Meanwhile, for write access from another host system with a low frequency of write access to the virtual volume, even if the capacity of chunks already allocated to virtual volumes exceeds the pool limit quota, the storage system allocates chunks to the virtual volume, enabling the write access from that host system.

In the above-described embodiment, a host system with a write access frequency comparatively higher than other host systems is judged a “rogue host,” and any application software operating on that host system is judged a “rogue program.” However, the present invention is not limited to the above case, and any specific host system or software can be determined as ‘rogue.’ In the above-described embodiment, the storage system notifies a host system of a write access error. Therefore, a spare logical volume having a physical storage area, rather than a virtual volume, may be provided in advance, and data may be transferred from the virtual volume to the spare volume at the same time the warning is issued, disconnecting the host system from the virtual volume. Consequently, it is possible for the host system to access the spare volume, enabling write access from the host system to the spare volume.

Furthermore, when there is no more storage area remaining in a pool, it is possible to add a storage area from another pool. In these cases, an FC drive can be used for a pool in SATA drives, but the reverse can be prohibited (if so desired).

What is claimed is:

1. A storage system comprising:
an interface that receives access from a host system;
one or more storage resources;
a controller that controls data input/output between the host system and the one or more storage resources;
control memory that stores control information necessary for executing that control;
a virtual volume that the host system recognizes; and
a pool having a plurality of storage areas that can be allocated to the virtual volume, the storage areas being provided by the one or more storage resources, wherein:
the controller allocates at least one storage area from among the storage areas in the pool to the virtual volume based on access from the host system to the virtual volume, and the host system accesses the storage area allocated to the virtual volume; the control memory includes limit control information limiting the allocation; and the controller limits the allocation of the storage area to the virtual volume based on the limit control information even when a storage area that can be allocated to the virtual volume is included in the pool.

2. The storage system according to claim 1, wherein:
the memory includes, as the control information, a limit value for the storage area allocated to the virtual volume as a result of write access from the host system to the virtual volume; and
when the capacity of the storage area allocated to the virtual volume exceeds the limit value, the controller limits the write access.

3. The storage system according to claim 2, wherein the memory includes, as control information, a limit value for the allocate-rate for allocating the storage area to the virtual volume, and when the value calculated as the allocate-rate exceeds the limit value, the controller limits the write access.

4. The storage system according to claim 2, wherein the limit value is set for the host system, and when the allocation of the storage area based on write access from the host system reaches the limit value, the controller issues a warning regarding the write access.

5. The storage system according to claim 2, wherein the limit value is set for the host system, and when the allocation of the storage area based on write access from the host system reaches the limit value, the controller regards that write access and any subsequent access as errors.

6. The storage system according to claim 2, wherein the limit value is set for the virtual volume, and when the allocation of the storage area based on write access from the host system reaches the limit value, the controller issues a warning regarding the write access.

7. The storage system according to claim 2, wherein the limit value is set for the virtual volume, and when the allocation of the storage area based on write access from the host system reaches the limit value, the controller regards that write access and any subsequent write access as errors.

8. The storage system according to claim 2, wherein when the storage areas in the pool already allocated to the virtual volume exceeds a limit set for the pool, the controller limits the allocation of a storage area from among the storage areas in the pool to the virtual volume based on write access from the host system.

9. The storage system according to claim 2, wherein the limit value is set for application software operating on the host system, and the controller limits write access from the application software.

10. The storage system according to claim 8, wherein the controller limits write access for application software operating on the host system, that has a high write access rate to the virtual volume.

11. The storage system according to claim 2, wherein the limit value varies according to the host system type.

12. The storage system according to claim 2, wherein the limit value varies according to the virtual volume usage.

13. A storage system comprising:
an interface that receives access from the host system;
one or more storage resources;
a controller that controls data input/output between the host system and the one or more storage resources;
control memory that stores control information necessary for executing that control;
a virtual volume that the host system recognizes; and
a pool having a plurality of storage areas that can be allocated to the virtual volume, the storage areas being provided by the one or more storage resources; wherein:
the controller allocates at least one storage area from among the storage areas in the pool to the virtual volume based on access from the host system to the virtual volume, and the host system accesses the storage area allocated to the virtual volume;
the control memory includes, as limit control information limiting the allocation, a limit value for the storage area allocated to the virtual volume as a result of write access from the host system to the virtual volume, set for the host system and the virtual volume, respectively; and
when the allocation of the storage area based on write access from the host system exceeds at least one of the limit value for the host system and the limit value for the virtual volume, the controller limits the write access from the host system.

14. The storage system according to claim 13, wherein a limit on write access is set for a specific host system that is determined in advance.

15. A storage system comprising a plurality of virtual volumes that are accessed by a plurality of host systems, different limit values being set for each of the host systems and each of the virtual volumes.

16. A storage control method for a storage system that dynamically allocates a storage area to a volume a host system accesses, in response to access from the host system, the method comprising:
pooling at least one storage area that can be allocated to the volume;
allocating, upon access from the host system to the volume, a storage area in the pool to the volume; and
returning, upon access from the host system exceeding an allocation limit provided to the host system and/or the volume for the allocation of the storage area, an error notice to the host system without allocating the storage area in the pool to the volume.
